(19) United States
(12) Patent Application Publication
(10) Pub. No.: US 2004/0128209 A1
(43) Pub. Date: Jul. 1, 2004

(54) Outsourcing management system and method

(76) Inventor: Ming Fang Tsai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/649,097

(22) Filed: Aug. 26, 2003

(30) Foreign Application Priority Data
Dec. 31, 2002 (TW) 91137950

(51) Int. Cl. G06F 17/60

(52) U.S. Cl. 705/26

(57) ABSTRACT

An outsourcing management system includes a plurality of client computers (3), a database server (4) linking to a database (5) for storing and managing basic information, an outsourcing management server (1), and a network (2) linking the above devices. The outsourcing management server includes a data obtaining module (100) for accessing data from external information systems, a data maintenance module (102) for maintaining basic information, an outsourcing transaction variation processing module (104) for processing variations occurring during outsourcing transactions, and an outsourcing transaction management module (106) for managing procedures in an outsourcing transaction. Said procedures include carrying forward outsourcing accounts to costs and expenses, and carrying forward accounting entries to general ledgers. A computer-enabled outsourcing management method is also disclosed. An outsourcing management method for processing outsourcing transaction variations is also disclosed.

### BACKGROUND OF THE INVENTION

1. Field of the Invention

The present invention relates to outsourcing management systems and methods, especially to an outsourcing management system and method that can process outsourcing transaction variations.

2. Background of the Invention

Procurement efficiency is vital for many companies, especially for mass-production manufacturers. Conventional procurement that is separate from inventory management, production, and accounting can retard the efficiency of a company's supply chain. Therefore, there is need for modern corporations to integrate procurement operations with production planning, inventory management, and accounting and auditing. Such integration is likely to improve production efficiency and simplify procurement management.

An outsourcing management system can integrate information on procurement, inventory and accounting, and help to select appropriate suppliers. The art of managing outsourcing processes is disclosed in patents such as U.S. Pat. No. 6,301,574 issued on Oct. 9, 2001 and entitled System for Providing Business Information. This patent discloses a system for checking purchased material against corresponding standards stored in a database when selecting suppliers. However, disadvantages of the system include the fact that no quantified indicators are provided for evaluating a supplier's credit, and that the system cannot satisfactorily deal with outsourcing transaction variations.

Conventional outsourcing management systems and methods are not able to integrate information on a supplier's credit and outsourcing transactions, generate outsourcing accounting entries, and process variations occurring during outsourcing transactions. As a result of poorly informed procurement or variations in outsourcing transactions, unsatisfactory or inappropriate material may be delivered, and delays may occur in obtaining correct material.

### SUMMARY OF THE INVENTION

A main objective of the present invention is to provide an outsourcing management system and method, whereby users can process variations occurring during outsourcing transactions.

To accomplish the above objective, an outsourcing management system in accordance with a preferred embodiment of the present invention comprises a plurality of client computers, a database server linking to a database for storing and managing basic information, an outsourcing management server, and a network linking the above devices. The outsourcing management server comprises: a data obtaining module for accessing data from external information systems; a data maintenance module for maintaining basic information; an outsourcing transaction variation processing module for processing variations occurring during outsourcing transactions; and an outsourcing transaction management module for managing procedures in an outsourcing transaction. Said procedures include carrying forward outsourcing accounts to costs and expenses, and carrying forward accounting entries to general ledgers.

Also, the present invention provides a preferred computer-enabled outsourcing management method comprising the steps of: (1) generating master outsourcing documents; (2) requiring an outsourcing payment; (3) checking by accountants of the outsourcing payment requisition, and paying for outsourcing material; (4) accepting delivered outsourcing material; and (5) carrying forward outsourcing accounts to costs.

Further, the present invention provides a preferred outsourcing management method for processing outsourcing transaction variations, the method comprising the steps of: (1) providing an information search module to search outsourcing transaction records; (2) providing an outsourcing transaction variation processing module to determine whether there are any variations occurring during an outsourcing transaction, and if so to determine whether it is necessary to cancel the outsourcing transaction; (3) carrying forward outsourcing accounts to costs if it is not necessary to cancel the outsourcing transaction; (4) carrying forward outsourcing accounts to expenses if it is necessary to cancel the outsourcing transaction; (5) generating accounting entries and outsourcing payment information; and (6) providing a general ledger management system to carry forward the accounting entries and outsourcing payment information to general ledgers.

Other objects, advantages and novel features of the present invention will be drawn from the following detailed description of the preferred embodiment and preferred methods of the present invention with the attached drawings, in which:

### BRIEF DESCRIPTION OF THE DRAWINGS

FIG. 1 is a schematic diagram of hardware configuration of architecture that includes an outsourcing management system in accordance with the preferred embodiment of the present invention;

FIG. 2 is a block diagram showing main function modules of an outsourcing management server of the outsourcing management system of FIG. 1;

FIG. 3 is a flowchart of a preferred method for implementing the outsourcing management system of the present invention; and

FIG. 4 is a flowchart of a preferred method for processing outsourcing transaction variations according to the present invention.

### DETAILED DESCRIPTION OF THE INVENTION

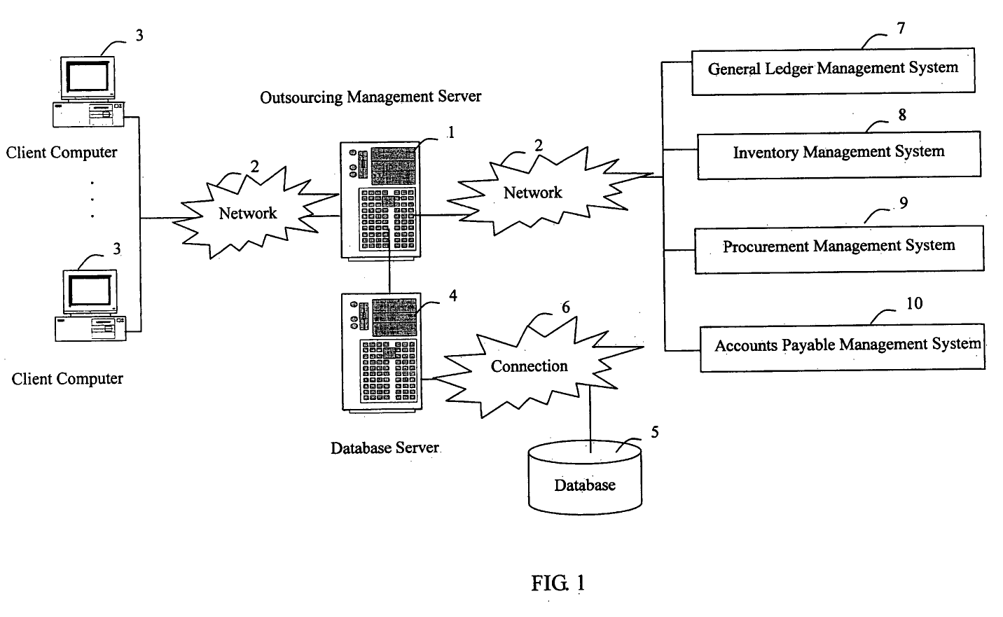

FIG. 1 is a schematic diagram of hardware configuration of architecture that includes an outsourcing management system in accordance with the preferred embodiment of the present invention. The outsourcing management system comprises a plurality of client computers 3, an outsourcing management server 1, a database server 4, and a network 2 linking the above devices. The outsourcing management server 1 is connected to a general ledger management system 7, an inventory management system 8, a procurement management system 9, and an accounts payable management system 10 through the network 2. The general ledger management system 7 is for storing and dealing with general ledgers of a company, and balancing the general ledgers according to accounts of various transactions. The inventory management system 8 is for managing inventory, and storing inventory data such as stock receipt information and purchase return information. The procurement management system 9 is for storing and managing procurement information including purchase records, total purchase costs, payment terms and payment dates. The accounts payable management system 10 is for storing and managing accounts payable information generated during outsourcing procedures. The outsourcing management server 1 may further comprise a notes payable management system (not shown in FIG. 1) connected to the general ledger management system 7 and the accounts payable management system 10 for storing and managing notes payable information.

The client computers 3 are located at workstations for users such as outsourcing operators. Each client computer 3 provides an interactive user interface for accessing information from the outsourcing management server 1, and for carrying out outsourcing operations such as maintaining basic information, and processing outsourcing transaction variations.

The outsourcing management server 1 comprises a plurality of function modules for receiving and managing information received from the client computers 3, and returning results to the client computers 3. The database server 4 is connected to a database 5 through a connection 6, which is database connectivity such as Open Database Connectivity (ODBC) or Java Database Connectivity (JDBC). The network 2 can be an intranet, the Internet, or any other suitable type of communications network.

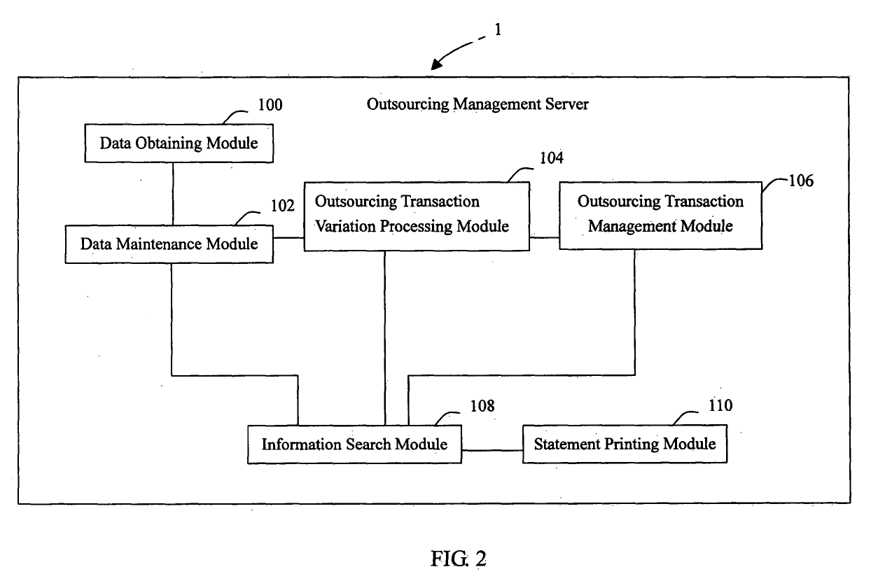

FIG. 2 is a block diagram showing main function modules of the outsourcing management server 1 of the outsourcing management system. The outsourcing management server 1 comprises a data obtaining module 100, a data maintenance module 102, an outsourcing transaction variation processing module 104, an outsourcing transaction management module 106, an information search module 108, and a statement printing module 110. The data obtaining module 100 accesses data from external information systems, and transfers data in the database server 4 to the external information systems. For example, the data obtaining module 100 can access stock receipt information from the inventory management system 8, and access data on manufacturers and purchase orders from the procurement management system 9. Also, the data obtaining module 100 can transmit outsourcing payment information to the accounts payable management system 10, and transmit accounting entries and outsourcing payment information to the general ledger management system 7.

The data maintenance module 102 maintains information of the outsourcing management system. The information includes outsourcing expenses, documents of outsourcing payments, accounting entries, and detailed documents of various transactions. The data maintenance module 102 can add to, modify and delete said information.

The outsourcing transaction variation processing module 104 is for processing variations occurring in outsourcing transactions. Such processing includes maintaining master outsourcing documents, and requiring prepaid expenses and outsourcing charges.

The outsourcing transaction management module 106 is for managing procedures in an outsourcing transaction. The procedures include carrying forward outsourcing accounts to costs and expenses, and carrying forward accounting entries to general ledgers.

The information search module 108 is for receiving search requisitions from the client computers 3, generating search requisition messages to be transmitted to the database server 4, and receiving search results from the database server 4. The search contents may include outsourcing payment information, outsourcing accounts, and detailed documents of carrying forward outsourcing accounts to costs and expenses.

The statement printing module 110 is for printing statements and basic information.

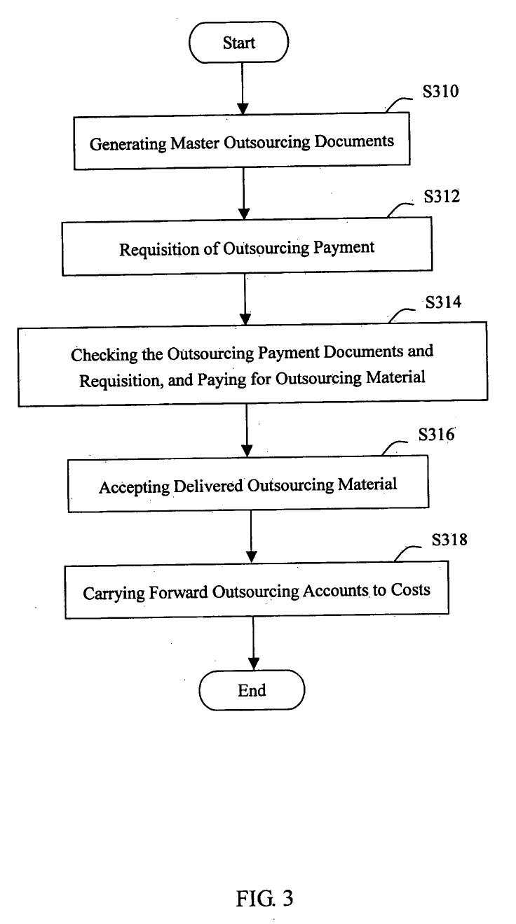

FIG. 3 is a flowchart of a preferred method for implementing the outsourcing management system of the present invention. Step S310 is a process of generating master outsourcing documents. Users first select a type of outsourcing voucher, and then input outsourcing information to the outsourcing voucher to generate a master outsourcing document. Step S312 is a process of outsourcing a payment requisition. The outsourcing transaction management module 106 automatically generates detailed outsourcing payment documents according to the master outsourcing documents, and submits a requisition for payment for the outsourcing material. Step S314 is a process of accounting approval and payment. Accountants check the detailed outsourcing payment documents including the requisition against data in the inventory management system 8, and arrange to pay for the outsourcing material if the outsourcing payment documents and the data in the inventory management system 8 are consistent. Step S316 is a process of material acceptance. The outsourcing management system automatically generates a document for checking and accepting delivered material according to material receipt bills and delivery bills obtained from the inventory management module 8. Step S320 is a process of carrying forward outsourcing accounts to costs. The outsourcing management system balances outsourcing accounts according to the master outsourcing documents and the detailed outsourcing payment documents, and generates a detailed document of carrying forward outsourcing accounts to costs.

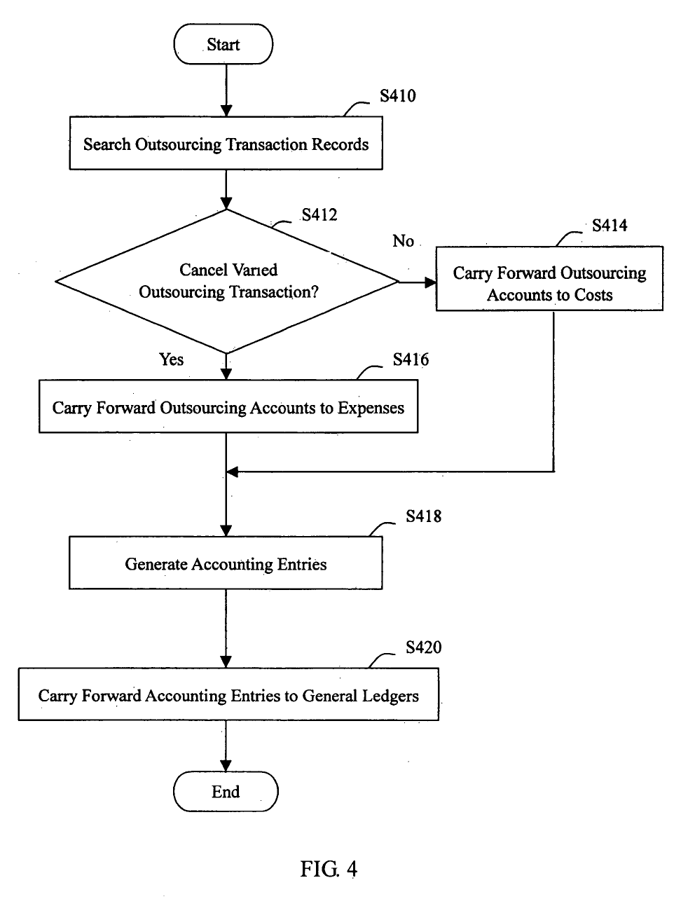

FIG. 4 is a flowchart of a preferred method for processing outsourcing transaction variations according to the present invention. In step S410, users search outsourcing transaction records through the information search module 108. In step S412, the outsourcing transaction variation processing module 104 determines whether there are any variations occurring during an outsourcing transaction. If any variations exist, the outsourcing transaction variation processing module 104 determines whether it is necessary to cancel the transaction. If it is not necessary to cancel the transaction, in step S414, the outsourcing transaction processing module 104 carries forward outsourcing accounts to costs. Otherwise, if it is necessary to cancel the transaction, in step S416, the outsourcing transaction processing module 104 carries forward outsourcing accounts to expenses. In step S418, the outsourcing management system automatically generates accounting entries and outsourcing payment information according to whichever of steps S414 and S416 is applicable. In step S420, the outsourcing management server 1 transmits the accounting entries and outsourcing payment information to the general ledger management system 7, and carries forward the accounting entries and the outsourcing payment information to general ledgers. In applicable of the above steps, users can print corresponding statements and basic information through the statement printing module 110.

Although the present invention has been specifically described on the basis of a preferred embodiment and preferred methods, the invention is not to be construed as being limited thereto. Various changes or modifications may be made to said embodiment and methods without departing from the scope and spirit of the invention.

What is claimed is:

1. An outsourcing management system for processing outsourcing transaction variations, the outsourcing management system comprising a plurality of client computers, a database server linking to a database for storing and managing information, and an outsourcing management server comprising:
a data obtaining module for accessing data from one or more external information systems;
a data maintenance module for maintaining information;
an outsourcing transaction variation processing module for processing variations occurring during outsourcing transactions; and
an outsourcing transaction management module for managing procedures in an outsourcing transaction, the procedures including carrying forward outsourcing accounts to costs and expenses, and carrying forward accounting entries to a general ledger.

2. The system according to claim 1, wherein the outsourcing management server further comprises an information search module for searching information stored in the database.

3. The system according to claim 1, wherein the outsourcing management server further comprises a statement printing module for printing corresponding statements and information.

4. The system according to claim 1, wherein the database server is connected to a database through a connection using database connectivity.

5. The system according to claim 1, wherein the one or more external information systems comprise any one or more of a general ledger management system, an inventory management system, a procurement management system, and an accounts payable management system.

6. A computer-enabled outsourcing management method comprising the steps of:
generating master outsourcing documents;
requiring an outsourcing payment;
checking the outsourcing payment requisition, and paying for outsourcing material;
accepting delivered outsourcing material; and
carrying forward outsourcing accounts to costs.

7. An outsourcing management method for processing outsourcing transaction variations, the method comprising the steps of:
(a) providing an information search module to search outsourcing transaction records;
(b) providing an outsourcing transaction variation processing module to determine whether there are any variations occurring during an outsourcing transaction, and if so to determine whether it is necessary to cancel the outsourcing transaction;
(c) carrying forward outsourcing accounts to costs if it is not necessary to cancel the outsourcing transaction;
(d) carrying forward outsourcing accounts to expenses if it is necessary to cancel the outsourcing transaction.

8. The method according to claim 7, after step (d), further including steps of:
(e) generating accounting entries and outsourcing payment information; and
(f) providing a general ledger management system to carry forward the accounting entries and outsourcing payment information to one or more general ledgers.
